(19) United States
(12) Patent Application Publication
(10) Pub. No.: US 2025/0313159 A1
(43) Pub. Date: Oct. 9, 2025

(54) ACCESSORY BRACKET ASSEMBLY FOR A VEHICLE

(71) Applicant: Textron Inc., Providence, RI (US)

(72) Inventors: Roger Dale Rhinehart, JR., N. Charleston, SC (US); Akeia Janae Nicole Williams, Augusta, GA (US); Nicole Ashley Morris, Grovetown, GA (US)

(73) Assignee: Textron Inc., Providence, RI (US)

(21) Appl. No.: 18/630,594

(22) Filed: Apr. 9, 2024

(51) Int. Cl. B60R 11/00

(52) U.S. Cl. CPC B60R 11/00; B60R 2011/0029; B60R 2011/0052

(57) ABSTRACT

A bracket assembly for coupling an accessory to a frame of a vehicle includes a first support configured to couple to a first portion of the frame; a second support coupled to the first support at a first end of the second support; a third support coupled to the first support at a first end of the third support and laterally spaced from the second support defining an opening therebetween; a fourth support coupled to a second end of the second support and a second end of the third support; and a fifth support coupled to the fourth support. The fourth support and the fifth support are configured to interface with a second portion of the frame with a fastener-less connection.

### BACKGROUND

Golf carts are commonly used by golfers while playing a round of golf to drive between holes, to their ball, and to carry their bags. Other vehicles, such as drink carts, ground maintenance vehicles, recreational vehicles, utility vehicles, etc. are also commonly found at a golf course. Accessories may be mounted to such vehicles to provide added functionality.

### SUMMARY

One embodiment relates to a bracket assembly for coupling an accessory to a frame of a vehicle. The bracket assembly includes a first support configured to couple to a first portion of the frame; a second support coupled to the first support at a first end of the second support; a third support coupled to the first support at a first end of the third support and laterally spaced from the second support defining an opening therebetween; a fourth support coupled to a second end of the second support and a second end of the third support; and a fifth support coupled to the fourth support. The fourth support and the fifth support are configured to interface with a second portion of the frame with a fastener-less connection.

Another embodiment relates to a frame assembly. The frame assembly includes a first frame rail; a second frame rail laterally spaced from the first frame rail such that the frame assembly includes a narrow portion, a wide portion, and a transition portion located between the narrow portion and the wide portion; a cross member configured to extend between the first frame rail and the second frame rail within the wide portion; and a bracket assembly configured to facilitate coupling an accessory with the frame assembly. The bracket assembly includes a plurality of lateral supports laterally spaced apart so as to define an opening sized to receive at least a portion of the accessory; a first interface configured to couple with the cross member; and a second interface configured to couple with the first frame rail and the second frame rail with a clamped, fastener-less engagement.

Still another embodiment relates to a bracket assembly for coupling an accessory to a frame of a golf cart. The bracket assembly includes a front support; a rear support including (i) a side flange and (ii) a bottom flange configured to couple to a first portion of the frame with one or more fasteners; a first lateral support including a rear interface positioned at a rear end of the first lateral support and a front interface positioned at a front end of the first lateral support, the rear interface of the first lateral support configured to couple to a first lateral end of the side flange, the front interface of the first lateral support configured to couple to a first lateral end of the front support; a second lateral support including a rear interface positioned at a rear end of the second lateral support and a front interface positioned at a front end of second first lateral support, the rear interface of the second lateral support configured to couple to an opposing second lateral end of the side flange, the front interface of the second lateral support configured to couple to an opposing second lateral end of the front support; and a clamp configured to releasably couple with the front support, the clamp including a bottom flange, an upper flange, and a middle flange extending between the bottom flange and the upper flange. When the clamp and the front support are coupled together, frame slots are (i) defined (a) on opposing sides of the bottom flange and the middle flange of the clamp and (b) between the upper flange and the front support, and (ii) configured to receive a second portion of the frame. The front support and the clamp are configured to interface with the second portion of the frame received by the frame slots defined by the clamp and the front support with a fastener-less connection. The first lateral support and the second lateral support are laterally spaced apart to provide an opening sized to receive at least a portion of the accessory.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a perspective view of a bracket assembly with an accessory, according to an exemplary embodiment.

FIG. 4 is a perspective view of the bracket assembly of FIG. 3 coupled with a frame of the vehicle of FIG. 1, according to an exemplary embodiment.

FIG. 5 is a perspective view of the bracket assembly and frame of FIG. 4 with various components of vehicle of FIG. 1 removed, according to an exemplary embodiment.

FIG. 6 is a left side view of the bracket assembly of FIG. 5, according to an exemplary embodiment.

FIG. 7 is a section view of section A-A of the bracket assembly of FIG. 5, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a vehicle of the present disclosure includes a bracket assembly configured to facilitate mounting an accessory with the vehicle. The bracket assembly may be coupled to a frame of the vehicle and include an accessory coupled therewith. The accessory may be or include a wireless charging receiver to facilitate transferring electrical energy from an external power source to an energy storage system of the vehicle to charge one or more batteries. Additionally or alternatively, the accessory may be a step, a nerf bar, a rock slider, a skid plate, or another type of accessory. The bracket assembly may include a first or rear support member configured to couple to a cross member of the frame, a second or front support member configured to interface with a first frame member and a second frame member of the frame, a third or first lateral support member configured to couple to the rear support member and the front support member, a fourth or second lateral support member laterally spaced from the first lateral support member and configured to couple to the rear support member and the front support member, and a clamp member configured to interface with the first frame member and the second frame member and couple to the front support member. The clamp member may be coupled to the front support member so as to provide a clamping force on the first frame member and the second frame member to facilitate coupling the bracket assembly with the chassis.

### Overall Vehicle

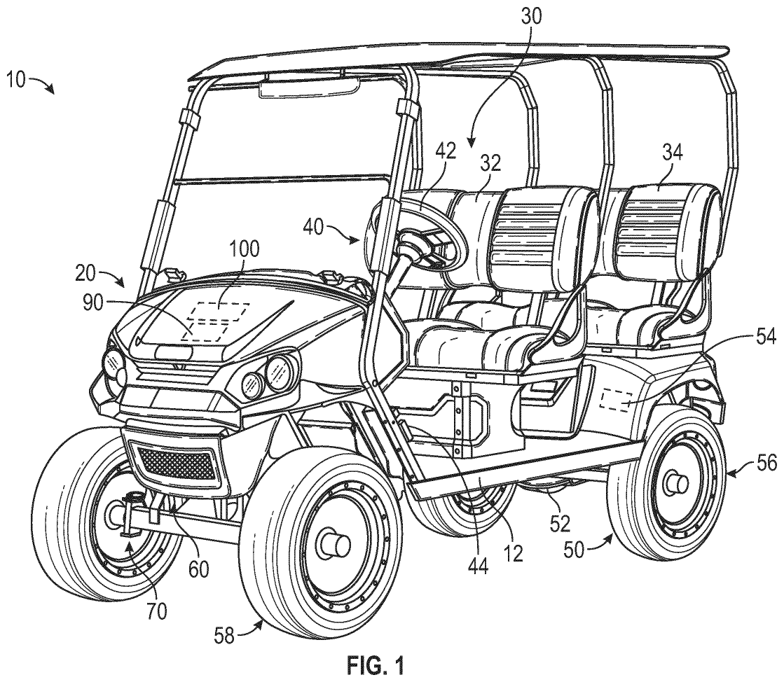

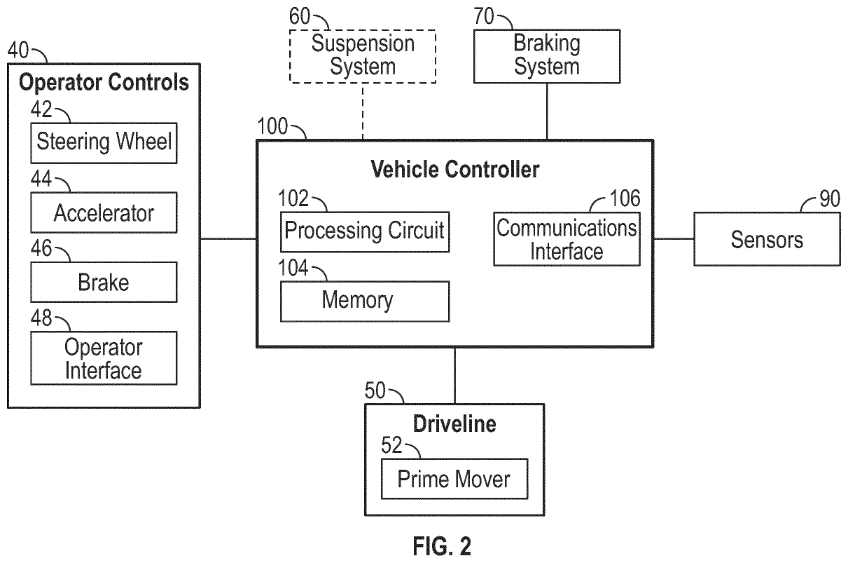

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more sensors, shown as sensors 90; and a vehicle control system, shown as vehicle controller 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements.

The sensors 90 may include various sensors positioned about the vehicle 10 to acquire vehicle information or vehicle data regarding operation of the vehicle 10 and/or the location thereof. By way of example, the sensors 90 may include an inertial measurement unit (“IMU”), an accelerometer, a gyroscope, a compass, a position sensor (e.g., a GPS sensor, etc.), suspension sensor(s), wheel sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 may represent a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle controller 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Mounting Bracket

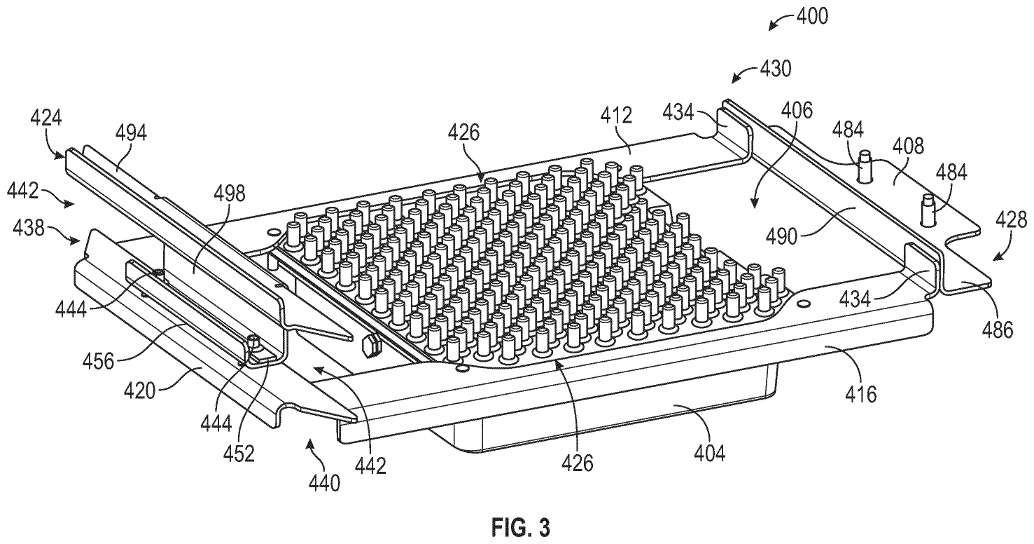

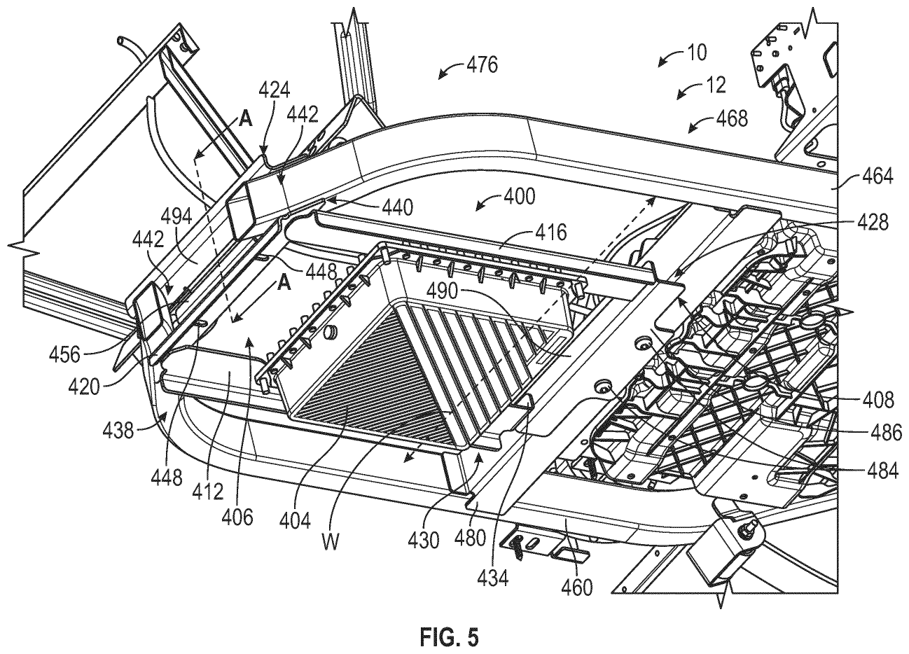

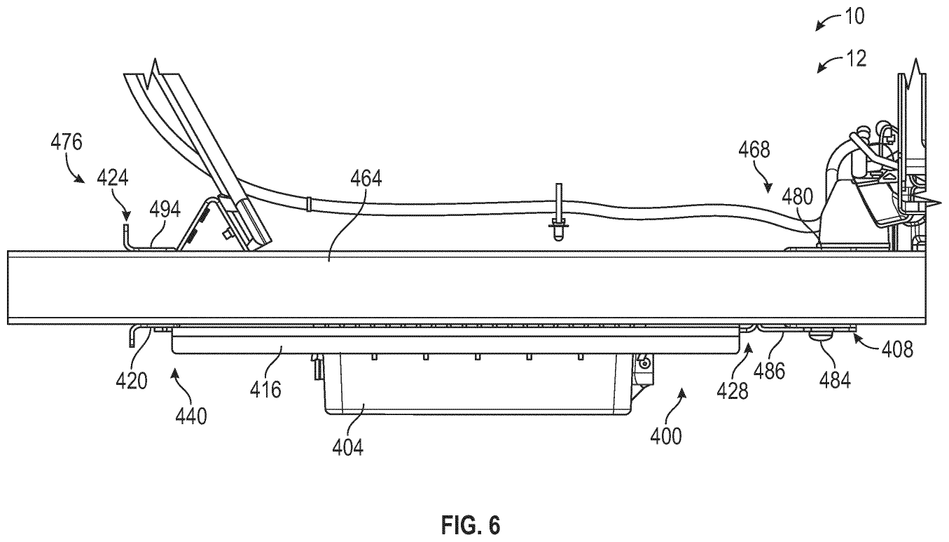

As shown in FIGS. 3-7, a mounting assembly (e.g., a mounting bracket, an accessory frame assembly, an accessory support kit, etc.), shown as bracket assembly 400, includes a plurality of support members configured to couple to the frame 12 of the vehicle 10 to facilitate coupling one or more accessories (e.g., a wireless charging receiver, a wireless charger, an inductive charging coil, a step, a nerf bar, a rock slider, a skid plate, etc.), shown as accessory 404, with the frame 12 of the vehicle 10. In some embodiments, the bracket assembly 400 facilitates coupling one or more various components of the vehicle 10 (e.g., the prime mover 52, the energy storage 54, a spare tractive element of the rear tractive assembly 56 and/or front tractive assembly 58, etc.) with the frame 12.

As shown in FIGS. 3-7, the bracket assembly 400 includes a first support member (e.g., cross member, lateral member, support, bracket, frame, beam, rail, etc.), shown as rear support 408, a second support member (e.g., longitudinal member, support, bracket, frame, beam, rail, etc.), shown as first lateral support 412, a third support member (e.g., longitudinal member, support, bracket, frame, beam, rail, etc.), shown as second lateral support 416, a fourth support member (e.g., longitudinal member, support, bracket, frame, beam, rail, etc.), shown as front support 420, and a fifth support or clamp member (e.g., clamp, U-bracket, hook, support, bracket, frame, beam, rail, etc.), shown as clamp 424. The rear support 408, the front support 420, and the clamp 424 are front and rear interfaces of the bracket assembly 400 configured to selectively couple (or otherwise interface) with the portions of the frame 12 of the vehicle 10. The first lateral support 412 and the second lateral support 416 are configured to couple to the front support 420 and the rear support 408 and structured to support the accessory 404, thereby facilitating selectively coupling the accessory 404 with the bracket assembly 400 and, thereby, the frame 12 of the vehicle 10. In some embodiments, the rear support 408, the first lateral support 412, the second lateral support 416, the front support 420, and/or the clamp 424 are formed from one or more bent, curved, angled, etc. sections (e.g., one or more pieces of material, one or more members formed together, etc.).

As shown in FIGS. 3-7, the first lateral support 412 and the second lateral support 416 (a) extend in a longitudinal direction (e.g., in a direction extending between a front end of the vehicle 10 and a rear end of the vehicle 10) between the rear support 408 and the front support 420 and (b) at least partially support the accessory 404. As shown in FIGS. 3-5, the first lateral support 412 and the second lateral support 416 are laterally spaced from each other to define an opening, shown as accessory opening 406, therebetween. According to an exemplary embodiment, the accessory opening 406 is sized such that the first lateral support 412 and the second lateral support 416 are sufficiently spaced to receive at least a portion of the accessory 404 therebetween. In some embodiments, at least a portion of the accessory 404 extends through the accessory opening 406, above the first lateral support 412 and the second lateral support 416. In some embodiments, at least a portion of the accessory 404 extends laterally outward from one or more of the first lateral support 412 and the second lateral support 416. In some embodiments, a plurality of the accessories 404 are coupled to and supported by the bracket assembly 400.

According to the exemplary embodiment shown in FIGS. 3-7, the accessory 404 is configured as or includes a wireless charger (e.g., charging receiver, receiving circuit, receiving coil, an induction charging coil, etc.) configured to wirelessly receive energy from an external power source and transfer the energy for storage with the energy storage 54 (e.g., when the driveline 50 is an electric driveline). Accordingly, the first lateral support 412 and the second lateral support 416 are laterally spaced from each other to provide the requisite space to mount the wireless charger thereto. In some embodiments, the accessory 404 additionally or alternatively is configured as or includes a step, a nerf bar, a rock slider, a skid plate, or another type of accessory (e.g., coupled to one of the first lateral support 412 or the second lateral support 416 and extending laterally outward therefrom such as a step, a nerf bar, a rock slider, etc.). In some embodiments, the first lateral support 412 and/or the second lateral support 412 include or are configured as nerf bars (e.g., a step, a rock slider, etc.). By way of example, the nerf bar may be or include an extension extending from the first lateral support 412 and/or the second lateral support 412 to provide a support surface for a user to enter or exit the vehicle 10 (e.g., the seating area 30).

As shown in FIG. 3, each of the first lateral support 412 and the second lateral support 416 defines a recessed region or portion, shown as notch 426, positioned along at least a portion of a longitudinal length thereof. The notches 426 may facilitate providing sufficient space to couple the accessory 404 to the bracket assembly 400 and with the vehicle 10. By way of example, the notches 426 may be structured (e.g., sized, shaped, positioned, etc.) to facilitate coupling a particular type of accessory 404 (e.g., the wireless charger) to the bracket assembly 400.

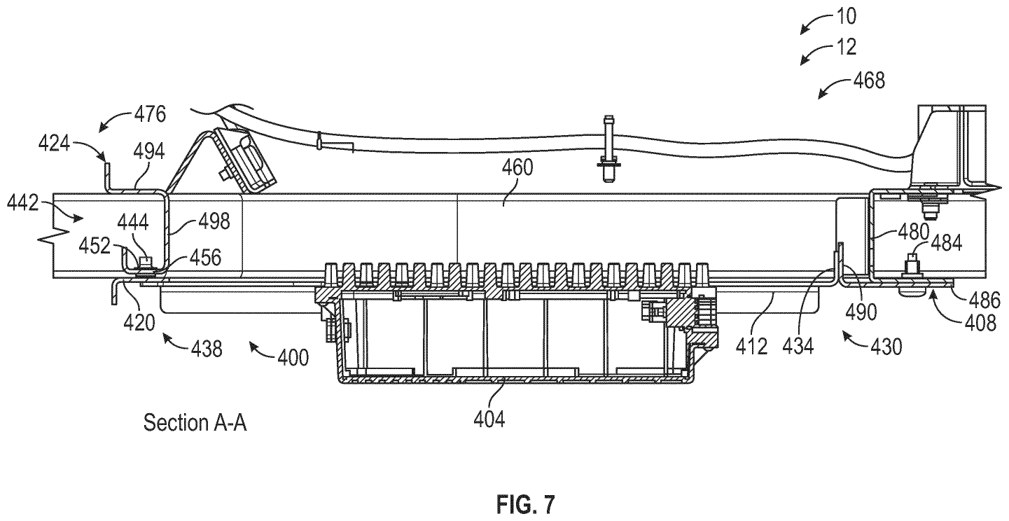

As shown in FIGS. 3-7, a first end, shown as rear end 428, of the first lateral support 412 is coupled to a first lateral end of the rear support 408 and a first end, shown as rear end 430, of the second lateral support 416 is coupled to an opposing second lateral end of the rear support 408. In some embodiments, the rear support 408 includes two separate members such that the rear end 428 of the first lateral support 412 couple to a first member of the two separate members of the rear support 408, and the rear end 430 of the second lateral support 416 couple to the second member of the two separate members of the rear support 408. As shown in FIGS. 3 and 7, each of the first lateral support 412 and the second lateral support 416 includes a first portion or rear interface, shown as flange 434, positioned at the rear end 428 and the rear end 430, respectively, thereof to facilitate coupling the first lateral support 412 and the second lateral support 416 to the rear support 408. In some embodiments, the flanges 434 of the first lateral support 412 and the second lateral support 416 are welded to the rear support 408 to couple the first lateral support 412 and the second lateral support 416 thereto. In other embodiments, the first lateral support 412 and the second lateral support 416 are otherwise coupled to the rear support 408. By way of example, the flanges 434 and the rear support 408 may include one or more apertures shaped to receive a fastener (e.g., bolt, screw, rivet, nail, anchor, etc.) to facilitate coupling the first lateral support 412 and the second lateral support 416 to the rear support 408. In such an example, the first lateral support 412 and the second lateral support 416 may be removably coupled to the rear support 408. In some embodiments, the first lateral support 412, the second lateral support 416, and the rear support 408 are integrally formed with each other to form a single unitary structure.

As shown in FIGS. 3-7, an opposing second end, shown as front end 438, of the first lateral support 412 is coupled to a first lateral end of the front support 420 and an opposing second end, shown as front end 440, of the second lateral support 416 is coupled to an opposing second lateral end of the front support 420. As shown in FIG. 3, a second portion or front interface of the first lateral support 412 proximate the front end 438 thereof and a second portion or front interface of the second lateral support 416 proximate the front end 440 thereof are coupled to a bottom surface (e.g., a downward facing surface) of the front support 420. In some embodiments, the first lateral support 412 and the second lateral support 416 are coupled to the front support 420 and the rear support 408 such that the first lateral support 412 and the second lateral support 416 extend substantially parallel to each other therebetween. In some embodiments, the first lateral support 412 and the second lateral support 416 are welded to the front support 420. In other embodiments, the first lateral support 412 and the second lateral support 416 are otherwise coupled to the front support 420. By way of example, the first lateral support 412, the second lateral support 416, and the front support 420 may include one or more apertures shaped to receive a fastener (e.g., bolt, screw, rivet, nail, anchor, etc.) to facilitate coupling the first lateral support 412 and the second lateral support 416 to the front support 420. In such an example, the first lateral support 412 and the second lateral support 416 may be removably coupled to the front support 420. In some embodiments, the first lateral support 412, the second lateral support 416, and the front support 420 are integrally formed with each other to form a single unitary structure. In some embodiments, the first lateral support 412, the second lateral support 416, the rear support 408, and the front support 420 are integrally formed with each other to form a single unitary structure.

As shown in FIGS. 3-7, the clamp 424 includes a first, bottom portion, shown as bottom flange 456, a second, upper portion, shown as upper flange 494, and a third, middle portion, shown as middle flange 498, extending between and coupling the bottom flange 456 and the upper flange 494 to each other. According to an exemplary embodiment, the bottom flange 456 and the middle flange 498 have a first width and the upper flange 494 has a second width that is larger than the first width.

As shown in FIGS. 3 and 7, the front support 420 is coupled to the clamp 424 using one or more fasteners (e.g., bolts, screws, rivets, nails, anchors, pins, etc.), shown as bolts 444. As shown in FIGS. 3-5, the front support 420 and the bottom flange 456 of the clamp 424 each define one or more apertures, shown as apertures 448, positioned to align and cooperatively receive the bolts 444. The bolts 444 extend through the apertures 448 defined by the front support 420 and the apertures 448 defined by the bottom flange 456 of the clamp 424 to secure (i) the front support 420 and the clamp 424 together and (ii) portions (e.g., frame rails) of the frame 12 between the front support 420 and the clamp 424. According to an exemplary embodiment, the front support 420 has a third width that is greater than the first width of the bottom flange 456 and the middle flange 498. The third width may be the same or about the same (e.g., within 5%) as the second width of the upper flange 494. As shown in FIGS. 3-5 and 7, the varying widths between (i) the bottom flange 456 and the middle flange 498 and (ii) the front support 420 and the upper flange 494 define passages, shown as frame slots 442. The frame slots 442 are (a) on opposing sides (e.g., opposing lateral sides) of the bottom flange 456 and the middle flange 498 and (b) between (e.g., vertically between) the front support 420 and the upper flange 494. The frame slots 442 can receive the frame rails of the frame 12 to secure the bracket assembly 400 to the frame 12. By way of example, when the front support 420 and the clamp 424 are coupled together, the varying widths between (i) the bottom flange 456 and the middle flange 498 and (ii) the front support 420 and the upper flange 494 define the frame slots 442.

As shown in FIG. 3, the bracket assembly 400 includes one or more retainers, shown as retainers 452, configured to secure the bolts 444 within the apertures 448. By way of example, the retainers 452 may be J-type nuts including threaded apertures configured to receive the bolts 444. The retainers 452 may be configured to clip (e.g., clamp, snap, or otherwise couple) onto the bottom flange 456 of the clamp 424 and positioned such that the threaded apertures defined by the retainers 452 are substantially aligned with the apertures 448 defined by the front support 420 and the apertures 448 defined by the clamp 424. The bolts 444 may extend through the apertures 448 defined by the front support 420, the apertures 448 defined by the clamp 424, and the threaded apertures defined by the retainers 452 to secure (i) the front support 420 and the clamp 424 together and (ii) portions (e.g., frame rails) of the frame 12 between the front support 420 and the clamp 424 (e.g., such that portions of the frame 12 are secured within the frame slots 442). The retainers 452 may be self-retaining such that they facilitate coupling the front support 420 and the clamp 424 together when access to one side of the bolts 444 (e.g., an end) extending therethrough is inhibited. By way of example, when the bolts 444 extend through the apertures 448 defined by the front support 420, the apertures 448 defined by the clamp 424, and the threaded apertures defined by the retainers 452, a head of the bolt 444 may be accessible, but a distal end of the bolt 444 may be substantially inaccessible. In such an example, the retainers 452 secure the bolt 444 within the apertures 448 when only the head of the bolt 444 is accessible. In other embodiments, another type of retainer 452 (e.g., a hex nut, a lock nut, a wing nut, etc.) is used to secure the bolt 444 within the apertures 448.

The bracket assembly 400 and one or more of the plurality of support members thereof may be selectively removably coupled to the frame 12. By way of example, the first lateral support 412 and/or the second lateral support 416 may be removed to facilitate coupling the accessory 404 with the vehicle 10 (e.g., to provide a sufficiently sized space to couple the accessory 404 to the bracket assembly 400). By way of another example, the rear support 408, the front support 420, and/or the clamp 424 may be removed to facilitate coupling the accessory 404 with the vehicle 10. Additionally or alternatively, the accessory 404 may be selectively removably coupled to or otherwise supported by the bracket assembly 400. By way of example, the accessory 404 may be removed to be replaced by an accessory 404 of the same type or an accessory of a different type (e.g., replacing a used battery with a new battery, replacing a nerf bar with a rock slider, etc.). In some embodiments, one or more of the plurality of support members (e.g., the first lateral support 412, the second lateral support 416, rear support 408, the front support 420, the clamp 424) are structured to support and couple a particular accessory 404 with the frame 12 of the vehicle 10. In one embodiment, the first lateral support 412 and the second lateral support 416 are structured to support a wireless charger, and in another embodiment, the first lateral support 412 and the second lateral support 416 are structured to support a step. In some embodiments, the bracket assembly 400 is structured to support the accessory 404 of a first type (e.g., the wireless charger) and the accessory 404 of a second type (e.g., the step) when the accessory 404 of the first type is replaced with the accessory 404 of the second type. In some embodiments, the bracket assembly 400 and the components thereof (e.g., the first lateral support 412, the second lateral support 416, rear support 408, the front support 420, the clamp 424) are structured to support a plurality of the accessories 404 at the same time. Such accessories may be the same type or different types.

The accessory 404 may be configured as a wireless charging coil (e.g., a receiver coil) configured to wirelessly receive electrical energy from an external charging coil (e.g., a charging station, a charging pad, an external power source, etc.). The charging coil may facilitate transferring the received electrical energy to the energy storage 54 of the vehicle 10 to charge one or more batteries included in the energy storage 54. By way of example, the vehicle 10 may include an electrical connector configured to establish a wired electrical connection between the charging coil and the energy storage 54. The external charger may receive electrical energy from an external power source, such as a battery bank, a generator, or a power grid and supply the received electrical energy to the charging coil. The vehicle 10 may approach the external charger to bring the charging coil in proximity to the external charger, and the external power source may wirelessly supply electrical energy to the vehicle 10 through the external charger and the charging coil. The bracket assembly 400 may be configured to secure the charging coil to the vehicle 10 at a certain height above a ground surface such that when the vehicle 10 approaches the external charger to bring the charging coil in proximity to the external charger, the charging coil and the external charger may be in wireless energy transfer communication.

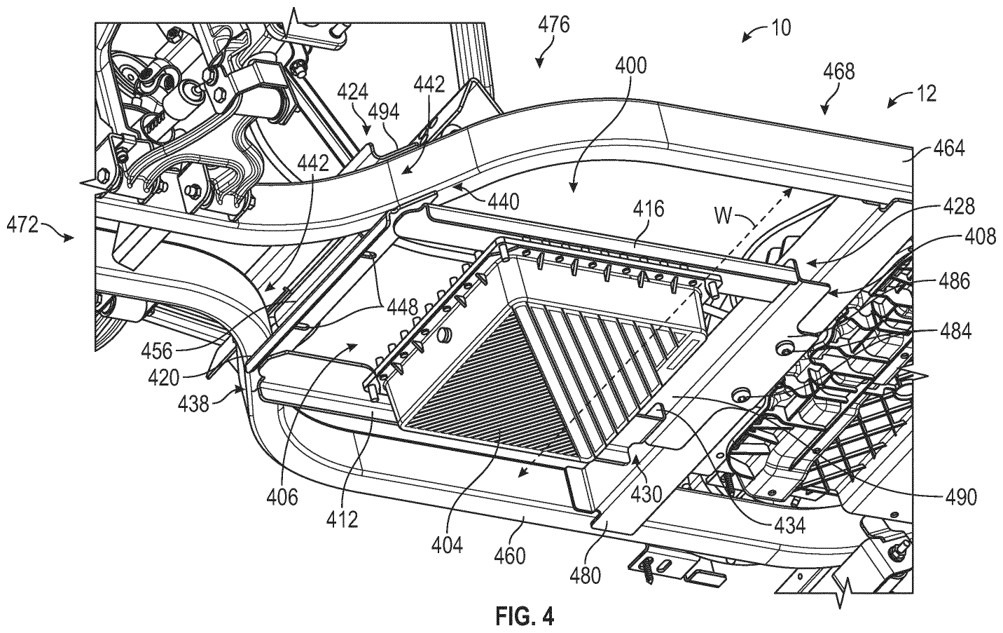

As shown in FIGS. 4-7, the bracket assembly 400 is coupled to the frame 12 of the vehicle 10 to facilitate coupling the accessory 404 with the vehicle 10. The frame 12 includes a first frame member, shown as first frame rail 460, and a second frame member, shown as frame rail 464, that are laterally spaced apart from each other. The frame 12 defines a width, shown as frame width W. The frame width W is defined by a lateral distance between the first frame rail 460 and the second frame rail 464 (e.g., between laterally inward facing surfaces thereof, between laterally outward facing surfaces thereof, between central planes thereof, etc.).

As shown in FIGS. 4-7, the first frame rail 460 and the second frame rail 464 are configured (e.g., shaped, structured, designed, etc.) such that the frame 12 includes a wide portion 468, a narrow portion 472, and a transition portion 476. The frame width W defined by sections or portions of the frame 12 within the wide portion 468 are larger than the frame width W defined by sections or portions of the frame 12 within the narrow portion 472. In other words, the wide portion 468 may be a section of the frame 12 defining a first lateral distance between the first frame rail 460 and the second frame rail 464 that is larger than a second lateral distance between a section of the first frame rail 460 and a section of the second frame rail 464 located within the narrow portion 472. In some embodiments, the first frame rail 460 and the second frame rail 464 extend in a longitudinal direction (e.g., in a direction extending between a front end of the vehicle 10 and a rear end of the vehicle 10) and are substantially parallel to each other within the wide portion 468 and the narrow portion 472.

As shown in FIGS. 4-7, the transition portion 476 is a section or portion of the frame 12 positioned between the wide portion 468 and the narrow portion 472. The transition portion 476 of the frame 12 may include one or more bent, curved, angled, etc. sections of the first frame rail 460 and the second frame rail 464 to facilitate transitioning the frame 12 between the wide portion 468 and the narrow portion 472. The frame width W defined by the sections of the frame 12 within the transition portion 476 may change or vary along a longitudinal direction. By way of example, the frame width W may gradually, incrementally, linearly, exponentially, etc., decrease as the first frame rail 460 and the second frame rail 464 extend in a longitudinal direction from the rear end of the vehicle 10 towards the front end of the vehicle 10. In such an embodiment, the narrow portion 472 may be positioned forward the transition portion 476 (e.g., in a direction closer to the front end of the vehicle 10), which may be positioned forward the wide portion 468. In other embodiments, the frame 12 is oriented such that the frame width W increases as the first frame rail 460 and the second frame rail 464 extend in a longitudinal direction from the rear end of the vehicle 10 towards the front end of the vehicle 10. In such an embodiment, the narrow portion 472 may be positioned rearward the transition portion 476 (e.g., in a direction closer to the rear end of the vehicle 10), which may be positioned rearward the wide portion 468.

As shown in FIGS. 4, 5, and 7, the frame 12 includes a rear cross member, shown as cross member 480, positioned within the wide portion 468 and extending laterally between the first frame rail 460 and the second frame rail 464. In some embodiments, the cross member 480 is integrally formed (e.g., welded) with the first frame rail 460 and the second frame rail 464 such that the frame 12 is a single unitary structure. In some embodiments, the cross member 480 is detachably coupled (e.g., with fasteners) to the first frame rail 460 and the second frame rail 464.

As shown in FIGS. 4, 5, and 7, the rear support 408 is configured to removably couple to the cross member 480 using one or more fasteners (e.g., bolts, screws, rivets, nails, anchors, pins, etc.), shown as fasteners 484. As shown in FIGS. 3-7, the rear support 408 includes a first portion, shown bottom flange 486, defining one or more apertures that receive the fasteners 484 to facilitate coupling the rear support 408 to the cross member 480, and a second portion, shown as side flange 490, configured to couple with the first lateral support 412 and the second lateral support 416 (e.g., the flanges 434 of the first lateral support 412 and the second lateral support 416, using fasteners, welded, etc.). In some embodiments, when the rear support 408 is coupled to the cross member 480, the side flange 490 of the rear support 408 is longitudinally spaced from the cross member 480 such that a gap is formed between the side flange 490 and the cross member 480 (e.g., as shown in FIG. 7). In other embodiments, when the rear support 408 is coupled to the cross member 480, the side flange 490 is not spaced from the cross member 480 and at least a portion of the side flange 490 is configured to contact the cross member 480.

As shown in FIGS. 3-7, the clamp 424 is configured to be coupled to the frame 12. The clamp 424 may be configured to couple to a section of the first frame rail 460 and a section of the second frame rail 464 within the transition portion 476 of the frame 12. The upper flange 494 and the bottom flange 456 of the clamp 424 may extend within parallel planes and are spaced apart from each other by way of the middle flange 498. In some embodiments, the upper flange 494 of the clamp 424 and the front support 420 define a lateral width that is the same as or greater than the frame width W at the location at which the clamp 424 and the front support 420 engage with the frame 12 (i.e., within the frame slots 442).

The upper flange 494 of the clamp 424 may be suitably dimensioned such that a downward facing surface of the upper flange 494 may be configured to interface with (e.g., contact, couple to, etc.) an upward facing (e.g., an upper) surface of the first frame rail 460 and the second frame rail 464 (e.g., as best shown in the cross-sectional view of FIG. 7). In such an embodiment, the first frame rail 460 and the second frame rail 464 may be configured to engage with and support the clamp 424. In some embodiments, the bottom flange 456 of the clamp 424 defines a lateral width that is at least less than the frame width W at the location at which the clamp 424 and the front support 420 engage with the frame 12 (i.e., within the frame slots 442). By way of example, when the clamp 424 is coupled with the frame 12, the upper flange 494 interfaces with the first frame rail 460 and the second frame rail 464, and the bottom flange 456 is positioned between the first frame rail 460 and the second frame rail 464. In some embodiments, one or more isolators (e.g., vibration dampeners) are positioned between the upper flange 494 and the first frame rail 460 and the second frame rail 464 at locations where the upper flange 494 interfaces with the first frame rail 460 and the second frame rail 464. In such an embodiment, when the vehicle 10 experiences vibrations, such vibrations propagating through the frame 12 and into the bracket assembly 400 may be reduced.

In some embodiments, the front support 420 defines a lateral width that is the same as or greater than the frame width W at the location at which the front support 420 is coupled with the frame 12. In some embodiments, the lateral width defined by the front support 420 is substantially the same as the lateral width defined by the upper flange 494 of the clamp 424. By way of example, the front support 420 may be suitably dimensioned such that an upward facing surface of the front support 420 may be configured to interface with (e.g., contact, couple to, etc.) a downward facing (e.g., a lower) surface of the first frame rail 460 and the second frame rail 464 (e.g., as best shown in the cross-sectional view of FIG. 7). In some embodiments, the clamp 424 and the front support 420 are a clamp assembly (e.g., a frame interface) defining the frame slots 442 and configured to receive the first frame rail 460 and the second frame rail 464 to secure the bracket assembly 400 thereto. When the front support 420 is coupled to the clamp 424 and the clamp 424 is coupled to the frame 12 (e.g., when the clamp 424 and the front support 420 engage with the frame 12 positioned within the frame slots 442), (i) the front support 420 may be configured to provide an upward clamping force on the first frame rail 460 and the second frame rail 464 and (ii) the upper flange 494 of the clamp 424 is configured to provide a downward clamping force on the first frame rail 460 and the second frame rail 464. In such an embodiment, the opposing upward and downward clamping forces on the first frame rail 460 and the second frame rail 464 may facilitate rigidly coupling (e.g., securing) the bracket assembly 400 with the frame 12. According to an exemplary embodiment, the configuration (e.g., arrangement, design, structure, etc.) of the front support 420 and the clamp 424 facilitate coupling the bracket assembly 400 to the transition portion 476 of the frame 12 with a clamped, fastener-less connection or coupling (i.e., without using bolts, rivets, screws, etc.). In some embodiments, one or more isolators (e.g., vibration dampeners) are positioned between the front support 420 and the first frame rail 460 and the second frame rail 464 at locations where the front support 420 interfaces with the first frame rail 460 and the second frame rail 464. In such an embodiment, when the vehicle 10 experiences vibrations, such vibrations propagating through the frame 12 and into the bracket assembly 400 may be reduced.

In some embodiments, the rear support 408 is configured to removably couple to (i) the cross member 480 and/or (ii) the first frame rail 460 and the second frame rail 464 with a clamped, fastener-less connection or coupling in a similar manner in which the front support 420 and the clamp 424 facilitate coupling the bracket assembly 420 to the transition portion 476 of the frame 12. By way of example, the rear support 408 and a clamp (e.g., the clamp 424) may provide a clamp assembly defining frame slots configured to receive the first frame rail 460 and the second frame rail 464 to secure the bracket assembly 400 thereto. In such an example, when the rear support 408 is coupled to the clamp and the clamp is coupled to the frame 12 (e.g., when the clamp and the rear support 408 engage with the frame 12 positioned within the frame slots), (i) the rear support 408 may be configured to provide an upward clamping force on (a) the cross member 480 and/or (b) the first frame rail 460 and the second frame rail 464 and (ii) an upper flange of the clamp may be configured to provide a downward clamping force on (a) the cross member 480 and/or (b) the first frame rail 460 and the second frame rail 464. The opposing upward and downward clamping forces on (i) the cross member 480 and/or (ii) the first frame rail 460 and the second frame rail 464 may facilitate rigidly coupling (e.g., securing) the bracket assembly 400 with the frame 12.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle controller 100, etc.) and the bracket assembly 400 (e.g., rear support 408, the first lateral support 412, the second lateral support 416, the front support 420, the clamp 424, etc.) as shown in the various exemplary embodiments is illustrative only. Additionally, any element disclosed in one embodiment may be incorporated or utilized with any other embodiment disclosed herein.

1. A bracket assembly for coupling an accessory to a frame of a vehicle, the bracket assembly comprising:
a first support configured to couple to a first portion of the frame;
a second support coupled to the first support at a first end of the second support;
a third support coupled to the first support at a first end of the third support and laterally spaced from the second support defining an opening therebetween;
a fourth support coupled to a second end of the second support and a second end of the third support; and
a fifth support coupled to the fourth support,
wherein the fourth support and the fifth support are configured to interface with a second portion of the frame with a fastener-less connection.

2. The bracket assembly of claim 1, wherein the opening defined by the second support and the third support is sized to receive at least a portion of the accessory.

3. The bracket assembly of claim 1, wherein the accessory includes a charger configured to receive energy from an external charger, and wherein the charger is coupled to the second support and the third support.

4. The bracket assembly of claim 1, wherein the accessory includes at least one of a step, a nerf bar, a rock slider, or a skid plate, and wherein the accessory is coupled to at least one of the second support or the third support.

5. The bracket assembly of claim 1, wherein the fourth support is configured to engage with a lower surface of the second portion of the frame, and wherein the fifth support is configured to engage with an upper surface of the second portion of the frame.

6. The bracket assembly of claim 5, further comprising a plurality of isolators configured to be positioned between the lower surface of the second portion and the fourth support and the upper surface of the second portion and the fifth support.

7. The bracket assembly of claim 1, wherein the first support is configured to couple to the first portion of the frame with (i) one or more fasteners or (ii) a fastener-less connection.

8. The bracket assembly of claim 7, wherein the frame includes a first frame rail, a second frame rail, and a cross member extending between the first frame rail and the second frame rail, and wherein the cross member is the first portion.

9. The bracket assembly of claim 1, wherein the frame includes a first frame rail and a second frame rail, wherein the first frame rail and the second frame rail define a wide portion, a narrow portion, and a transition portion between the wide portion and the narrow portion, and wherein the second portion of the frame is the transition portion.

10. The bracket assembly of claim 1, wherein the frame includes a first frame rail and a second frame rail, wherein the fifth support includes a bottom flange defining a first width, an upper flange defining a second width that is greater than the first width of the bottom flange, and a middle flange extending between and coupling the bottom flange and the upper flange together, and wherein the fourth support defines a third width that is greater than the first width of the bottom flange.

11. The bracket assembly of claim 10, wherein a pair of frame slots are defined (i) on opposing sides of the bottom flange and the middle flange of the fifth support and (ii) between the fourth support and the upper flange of the fifth support.

12. The bracket assembly of claim 11, wherein the pair of frame slots receive at least a portion of the first frame rail and at least a portion of the second frame rail such that the fourth support and the upper flange of the fifth support engage with the first frame rail and the second frame rail to secure the bracket assembly to the frame.

13. The bracket assembly of claim 10, wherein each of the bottom flange of the fifth support and the fourth support defines at least one aperture positioned to align and cooperatively receive a fastener to couple the fifth support and the fourth support together.

14. The bracket assembly of claim 13, further comprising a self-retaining retainer configured to receive the fastener.

15. The bracket assembly of claim 1, wherein each of the second support and the third support includes an interface positioned at the first end of the second support and the first end of the third support, wherein the interface of the second support is coupled to a first lateral end of a flange of the first support, and wherein the interface of the third support is coupled to an opposing second lateral end of the flange of the first support.

16. A frame assembly comprising:
a first frame rail;
a second frame rail laterally spaced from the first frame rail such that the frame assembly includes a narrow portion, a wide portion, and a transition portion located between the narrow portion and the wide portion;
a cross member configured to extend between the first frame rail and the second frame rail within the wide portion; and
a bracket assembly configured to facilitate coupling an accessory with the frame assembly, the bracket assembly including:
a plurality of lateral supports laterally spaced apart so as to define an opening sized to receive at least a portion of the accessory;
a first interface configured to couple with the cross member; and
a second interface configured to couple with the first frame rail and the second frame rail with a clamped, fastener-less engagement.

17. The frame assembly of claim 16, wherein the second interface includes a clamp assembly, the clamp assembly defining frame slots configured to receive the first frame rail and the second frame rail to secure the bracket assembly thereto.

18. The frame assembly of claim 17, wherein the clamp assembly includes:
an upper flange configured to engage with at least a portion of an upward facing surface of the first frame rail and at least a portion of an upward facing surface of the second frame rail; and
a lower support configured to engage with at least a portion of a downward facing surface of the first frame rail and at least a portion of a downward facing surface of the second frame rail.

19. The frame assembly of claim 18, wherein the upper flange and the lower support are configured to provide a clamping force on the first frame rail and the second frame rail to facilitate coupling the bracket assembly with the first frame rail and the second frame rail.

20. A bracket assembly for coupling an accessory to a frame of a golf cart, the bracket assembly comprising:
a front support;
a rear support including (i) a side flange and (ii) a bottom flange configured to couple to a first portion of the frame with one or more fasteners;
a first lateral support including a rear interface positioned at a rear end of the first lateral support and a front interface positioned at a front end of the first lateral support, the rear interface of the first lateral support configured to couple to a first lateral end of the side flange, the front interface of the first lateral support configured to couple to a first lateral end of the front support;
a second lateral support including a rear interface positioned at a rear end of the second lateral support and a front interface positioned at a front end of second first lateral support, the rear interface of the second lateral support configured to couple to an opposing second lateral end of the side flange, the front interface of the second lateral support configured to couple to an opposing second lateral end of the front support; and
a clamp configured to releasably couple with the front support, the clamp including a bottom flange, an upper flange, and a middle flange extending between the bottom flange and the upper flange,
wherein, when the clamp and the front support are coupled together, frame slots are (i) defined (a) on opposing sides of the bottom flange and the middle flange of the clamp and (b) between the upper flange and the front support, and (ii) configured to receive a second portion of the frame,
wherein the front support and the clamp are configured to interface with the second portion of the frame received by the frame slots defined by the clamp and the front support with a fastener-less connection, and
wherein the first lateral support and the second lateral support are laterally spaced apart to provide an opening sized to receive at least a portion of the accessory.
